(19) United States
(12) Patent Application Publication
(10) Pub. No.: US 2015/0177552 A1
(43) Pub. Date: Jun. 25, 2015

(54) DRIVING SYSTEM ARCHITECTURE OF LIQUID CRYSTAL DISPLAY PANEL AND LIQUID CRYSTAL DISPLAY USING THE SAME

(71) Applicant: SHENZHEN CHINA STAR OPTOELECTRONICS TECHNOLOGY CO. LTD., Shenzhen, Guangdong (CN)

(72) Inventor: Shen-Sian Syu, Shenzhen (CN)

(21) Appl. No.: 14/240,388

(22) PCT Filed: Jan. 22, 2014
(86) PCT No.: PCT/CN2014/071087

§ 371 Date: Jul. 30, 2014

(30) Foreign Application Priority Data
Dec. 25, 2013 (CN) 201310731374.6

(51) Int. Cl. G02F 1/1345; G02F 1/133

(52) U.S. Cl. CPC G02F 1/13452; G02F 1/13306

(57) ABSTRACT

The present disclosure discloses a driving system architecture of a liquid crystal display panel and a liquid crystal panel using the same. The driving system architecture includes: at least two Source Driver ICs corresponding to a plurality of different circuit boards respectively, for supplying data line voltages to the liquid crystal display panel; a control board connected to the plurality of circuit boards; and a P-Gamma IC, arranged in one of the plurality of circuit boards and electrically connected to the Source Driver IC corresponding to said one of the plurality of circuit boards for supplying a reference voltage to the Source Driver IC, wherein the P-Gamma IC supplies reference voltages to other Source Driver ICs by wires of the control board and other circuit boards. In the present disclosure, by arranging the P-Gamma IC on the circuit board rather than on the control board, the client does not have to fit the P-Gamma IC to a specific control board during assembly, thus lowering delivery costs and the risk of assembly errors.

### FIELD OF THE INVENTION

The present disclosure relates to the field of liquid crystal displays, and particularly relates to a driving system architecture of a liquid crystal display panel and a liquid crystal display using the same.

### BACKGROUND OF THE INVENTION

In recent years, as a thinning trend among displays develops, Liquid Crystal Displays (LCDs for short) have been widely used in various electronic products, such as mobile phones, notebook computers, and color televisions.

A P-Gamma IC is widely used in liquid crystal display products, thanks to its ability of automatically detecting and adjusting a voltage via a sensor in combination with software to improve accuracy in a voltage changing process, so as to further reduce flicker and adjust a most suitable color for the user.

Generally, on a high-resolution panel, the P-Gamma IC is arranged on a Control Board (C board for short), and supplies a voltage to a circuit board of a Source Driver IC through a Flexible Flat Cable (FFC for short), specifically as shown in FIG. 1.

However, when goods are delivered to customers, panels with circuit boards and C boards are separately delivered. In this case, the following problems may appear: some panel manufacturers may update the voltages of P-Gamma ICs for different panels, so that the corresponding panel must be adjusted for each C board, thus increasing delivery costs and the risk of assembling wrong panels to the P-Gamma ICs.

Accordingly, how to solve the above-mentioned problems so as to lower the delivery costs and reduce assembly errors of P-Gamma ICs is desirable to be addressed in the industry.

### SUMMARY OF THE INVENTION

One of the technical problems to be solved in the present disclosure is to provide a driving system architecture of a liquid crystal display panel, which can reduce delivery costs and assembly errors of P-Gamma ICs. In addition, the present disclosure further provides a liquid crystal display using the system architecture.

1) To solve the above-mentioned technical problems, the present disclosure provides a driving system architecture of a liquid crystal display panel, including: at least two Source Driver ICs corresponding to a plurality of different circuit boards respectively, for supplying data line voltages to the liquid crystal display panel; a control board connected to the plurality of circuit boards; and a P-Gamma IC, arranged in one of the plurality of circuit boards and electrically connected to the Source Driver IC corresponding to said one of the plurality of circuit boards for supplying a reference voltage to the Source Driver IC, wherein the P-Gamma IC supplies reference voltages to other Source Driver ICs by wires of the control board and other circuit boards.

2) In one preferred embodiment of item 1) of the present disclosure, a voltage dividing circuit is added on the wire of the P-Gamma IC, so as to enable equal reference voltages supplied to the plurality of Source Driver ICs by the P-Gamma IC.

3) In one preferred embodiment of items 1) or 2) of the present disclosure, a compensation resistor is added on the wire of the P-Gamma IC, so as to enable equal resistances between the P-Gamma IC and the plurality of Source Driver ICs, thus further enabling equal reference voltages supplied to the plurality of Source Driver ICs by the P-Gamma IC.

4) In one preferred embodiment of any one of items 1) to 3) of the present disclosure, when two Source Driver ICs are provided, the compensation resistor is added on the circuit board where the P-Gamma IC is located, so that the sum value of the wire resistance of the circuit board and the compensation resistance is equal to the wire resistance of the P-Gamma IC and the other Source Driver IC.

5) In one preferred embodiment of any one of items 1) to 4) of the present disclosure, when an odd number of Source Driver ICs are provided, the P-Gamma IC is arranged on the circuit board corresponding to the Source Driver IC placed in the middle.

6) According to another aspect of the present disclosure, it further provides a liquid crystal display, including: a liquid crystal display panel, and a driving system architecture. The driving system architecture includes: at least two Source Driver ICs which are corresponding to a plurality of different circuit boards respectively, for supplying data line voltages to the liquid crystal display panel; a control board connected to the plurality of circuit boards; and a P-Gamma IC, arranged in one of the plurality of circuit boards and electrically connected to the Source Driver IC corresponding to said one of the plurality of circuit boards for supplying a reference voltage to the Source Driver IC, wherein the P-Gamma IC supplies reference voltages to other Source Driver ICs by wires of the control board and other circuit boards.

7) In one preferred embodiment of item 6) of the present disclosure, a voltage dividing circuit is added on the wire of the P-Gamma IC, so as to enable equal reference voltages supplied to the plurality of Source Driver ICs by the P-Gamma IC.

8) In one preferred embodiment of item 6) or 7) of the present disclosure, a compensation resistor is added on the wire of the P-Gamma IC, so as to enable equal resistances between the P-Gamma IC and the plurality of Source Driver ICs, thus further enabling equal reference voltages supplied to the plurality of Source Driver ICs by the P-Gamma IC.

9) In one preferred embodiment of any one of items 6) to 8) of the present disclosure, when two Source Driver ICs are provided, the compensation resistor is added on the circuit board where the P-Gamma IC is located, so that the sum value of the wire resistance and the compensation resistance on the circuit board is equal to the wire resistance between the P-Gamma IC and the other Source Driver IC.

10) In one preferred embodiment of any one of items 6) to 9) of the present disclosure, when an odd number of Source Driver ICs are provided, the P-Gamma IC is arranged on the circuit board corresponding to the Source Driver IC placed in the middle.

Compared with the prior art, one or a plurality of examples of the present disclosure may have the following advantages.

The P-Gamma IC according to the present disclosure is arranged on the circuit board rather than on the control board, so that the client does not have to fit the P-Gamma IC to a specific control board during assembly, thus lowering delivery costs and the risk of assembly errors. In addition, the voltage dividing circuit is introduced in the present disclosure, which is generally realized by using the controlled-source voltage terminal having a lower voltage as a reference voltage aided by voltage dividing resistors of other control circuits, thus eliminating optical brightness deviation caused by voltage inconsistency.

Other features and advantages of the present disclosure will be illustrated in the following description, and become partially obvious from the description, or understood through implementing the present disclosure. The objectives and other advantages of the present disclosure may be realized and obtained through the structures specified in the description, claims, and accompanying drawings.

### BRIEF DESCRIPTION OF THE DRAWINGS

The accompanying drawings, which are provided for further understanding the present disclosure, constitute a part of the description, and are used for interpreting the present disclosure together with the examples of the present disclosure, rather than to limit the present disclosure. In the accompanying drawings:

FIG. 1 is a schematic diagram of a driving system assembly connecting architecture of a liquid crystal display panel in the prior art;

FIG. 2 is a schematic diagram of a driving system architecture of a liquid crystal display panel according to an example of the present disclosure; and

FIG. 3 is a schematic diagram of a driving system architecture of a liquid crystal display panel according to another example of the present disclosure.

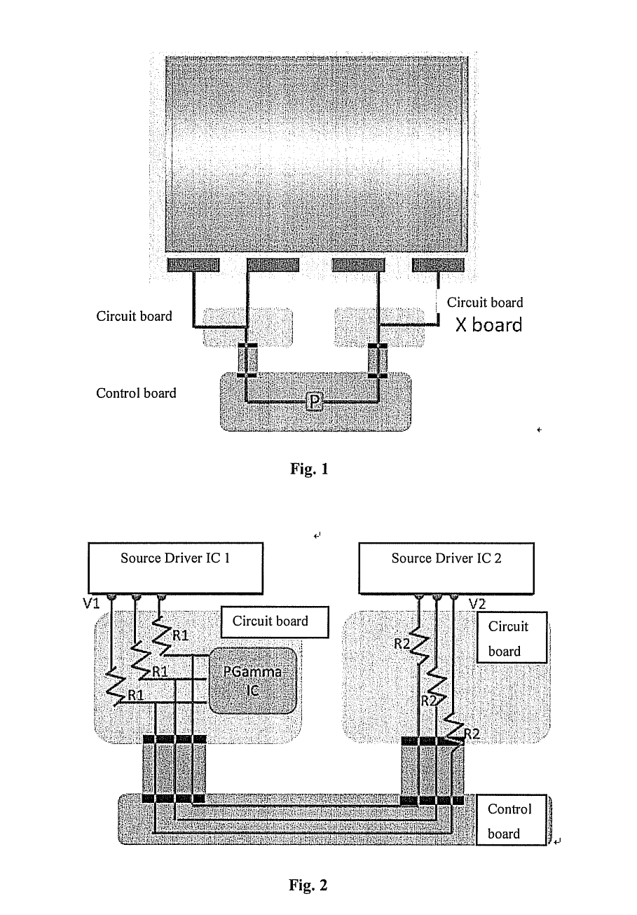

### DETAILED DESCRIPTION OF THE EMBODIMENTS

To make the objectives, technical solutions, and advantages of the present disclosure clearer, the present disclosure is further illustrated in detail below in conjunction with the accompanying drawings.

FIG. 2 is a schematic diagram of a driving system architecture of a liquid crystal display panel according to an example of the present disclosure. The structure of the system architecture will be illustrated below with reference to FIG. 2.

As shown in FIG. 2, the system architecture includes a control board (C board), a P-Gamma IC, and at least two Source Driver ICs corresponding to different circuit boards, respectively. To facilitate illustration, only two circuit boards are included in FIG. 2. It can be easily understood that FIG. 2 shows merely one example, and does not limit the number of the circuit boards in any manner.

The Source Driver ICs are used for supplying voltages of TFT data lines to the liquid crystal display panel, and the P-Gamma IC is used for supplying reference voltages to the Source Driver ICs. The plurality of circuit boards each are connected to the C board via an FFC, respectively.

It can be seen from FIG. 2 that instead of being arranged on the C board as in the prior art, the P-Gamma IC is arranged on one of the plurality of circuit boards. Moreover, a wire impedance R1 between the P-Gamma IC and a Source Driver IC 1, and a wire impedance R2 between the P-Gamma IC and a Source Driver IC 2 are schematically shown. The voltage supplied by the P-Gamma IC is transmitted to the corresponding Source Driver IC via FFC wires, for example. That is to say, the P-Gamma IC is arranged in one of the plurality of circuit boards and electrically connected to the Source Driver IC 1 corresponding to said one of the plurality of circuit boards so as to supply a reference voltage to the Source Driver IC 1, and the P-Gamma IC supplies a reference voltage to another Source Driver IC (the Source Driver IC 2) via wires of the C board and another circuit board.

According to the above connecting architecture, the P-Gamma IC is arranged on the circuit board rather than on the C board, so that the liquid crystal display panel has been set with corresponding parameters before leaving the factory, and therefore does not need to be updated after leaving the factory. Moreover, the P-Gamma IC does not need to be assembled with a specific C board during a later assembly step by the customers. Thus, delivery costs and the risk of assembly errors may be reduced.

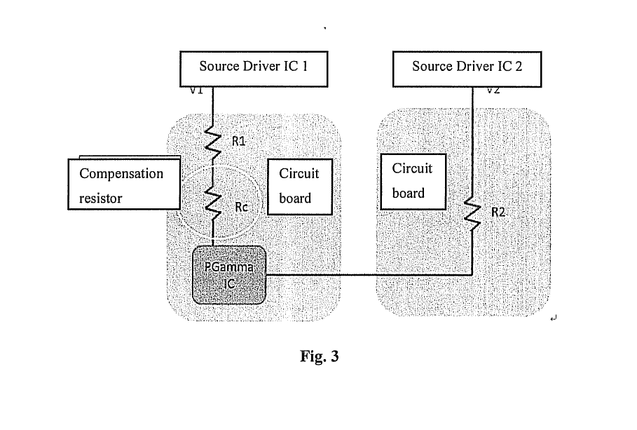

The present disclosure further provides another example, as specifically shown in FIG. 3, which is an improvement based on FIG. 2. The portions in FIG. 3 the same as those shown FIG. 2 are not to be repeatedly described herein, and only the differences from FIG. 2 are to be illustrated in detail.

In this example as shown in FIG. 3, a compensation resistor Rc is added on the wire of the circuit board where the P-Gamma IC is located, so that the wire impedances from the P-Gamma IC to the plurality of Source Driver ICs are equal to each other.

As shown in FIG. 3, to facilitate illustration, only the wire impedance R1 on one of the circuit boards and the wire impedance R2 on another of the circuit boards are shown. Moreover, a compensation resistor Rc is connected in series to the wire impedance R1, so that the following equation is satisfied: R1+Rc=R2. As the wire impedances from the P-Gamma IC to the plurality of Source Driver ICs are the same, the transmitted reference voltages V1=V2, thus improving optical brightness distortion caused by inconsistent voltages. That is to say, addition of the compensation resistor on the wire of the P-Gamma IC enables equal resistances between the P-Gamma IC and the plurality of Source Driver ICs, and thus further enables equal reference voltages supplied to the plurality of Source Driver ICs by the P-Gamma IC.

Certainly, the above compensation resistor is merely one example, and a voltage dividing circuit in other forms may be adopted for voltage division, so that the reference voltages supplied to the plurality of Source Driver ICs by the P-Gamma IC are equal.

In addition, when the number of the Source Driver ICs is odd, the P-Gamma IC is arranged on the circuit board corresponding to the Source Driver IC placed in the middle. In this way, when the compensation resistor is disposed, excessive compensation resistors are unnecessary, so that costs and loss on circuits may be reduced.

Moreover, the present disclosure further provides a liquid crystal display, including the above-mentioned driving system architecture.

In conclusion, the P-Gamma IC is arranged on the circuit board rather than on the C board in the present disclosure, so that the client does not have to fit the P-Gamma IC to a specific C board during assembly, thus lowering delivery costs and the risk of assembly errors. Besides, a voltage dividing circuit is introduced in the present disclosure, which is generally realized by using the controlled-source voltage terminal having a lower voltage as a reference voltage, aided by voltage dividing resistors of other control circuits, thus eliminating optical brightness deviation caused by voltage inconsistency.

In the foregoing, merely preferred specific embodiments of the present disclosure are listed, but the scope of the present disclosure is not limited thereto. Readily conceivable variations or substitutions by one skilled in the art within the disclosed technical scope of the present disclosure shall be incorporated in the present disclosure. Accordingly, the scope of the present disclosure is defined by the following claims.

1. A driving system architecture of a liquid crystal display panel, including:
at least two Source Driver ICs corresponding to a plurality of different circuit boards respectively, for supplying data line voltages to the liquid crystal display panel;
a control board connected to the plurality of circuit boards; and
a P-Gamma IC, arranged in one of the plurality of circuit boards and electrically connected to the Source Driver IC corresponding to said one of the plurality of circuit boards for supplying a reference voltage to the Source Driver IC, wherein the P-Gamma IC supplies reference voltages to other Source Driver ICs by wires of the control board and other circuit boards.

2. The driving system architecture according to claim 1, wherein
a voltage dividing circuit is added on the wire of the P-Gamma IC, so as to enable equal reference voltages supplied to the plurality of Source Driver ICs by the P-Gamma IC.

3. The driving system architecture according to claim 2, wherein
a compensation resistor is added on the wire of the P-Gamma IC, so as to enable equal resistances between the P-Gamma IC and the plurality of Source Driver ICs, thus further enabling equal reference voltages supplied to the plurality of Source Driver ICs by the P-Gamma IC.

4. The driving system architecture according to claim 3, wherein
when two Source Driver ICs are provided, the compensation resistor is added on the circuit board where the P-Gamma IC is located, so that the sum value of the wire resistance of the circuit board and the compensation resistance is equal to the wire resistance of the P-Gamma IC and the other Source Driver IC.

5. The driving system architecture according to claim 1, wherein
when an odd number of Source Driver ICs are provided, the P-Gamma IC is arranged on the circuit board corresponding to the Source Driver IC placed in the middle.

6. A liquid crystal display, including:
a liquid crystal display panel, and
a driving system architecture which includes:
at least two Source Driver ICs which are corresponding to a plurality of different circuit boards respectively, for supplying data line voltages to the liquid crystal display panel;
a control board connected to the plurality of circuit boards; and
a P-Gamma IC, arranged in one of the plurality of circuit boards and electrically connected to the Source Driver IC corresponding to said one of the plurality of circuit boards for supplying a reference voltage to the Source Driver IC, wherein the P-Gamma IC supplies reference voltages to other Source Driver ICs by wires of the control board and other circuit boards.

7. The liquid crystal panel according to claim 6, wherein
a voltage dividing circuit is added on the wire of the P-Gamma IC, so as to enable equal reference voltages supplied to the plurality of Source Driver ICs by the P-Gamma IC.

8. The liquid crystal panel according to claim 7, wherein
a compensation resistor is added on the wire of the P-Gamma IC, so as to enable equal resistances between the P-Gamma IC and the plurality of Source Driver ICs, thus further enabling equal reference voltages supplied to the plurality of Source Driver ICs by the P-Gamma IC.

9. The liquid crystal panel according to claim 8, wherein
when two Source Driver ICs are provided, the compensation resistor is added on the circuit board where the P-Gamma IC is located, so that the sum value of the wire resistance of the circuit board and the compensation resistance is equal to the wire resistance of the P-Gamma IC and the other Source Driver IC.

10. The liquid crystal panel according to claim 6, wherein
when an odd number of Source Driver ICs are provided, the P-Gamma IC is arranged on the circuit board corresponding to the Source Driver IC placed in the middle.
